(19) United States
(12) Patent Application Publication
(10) Pub. No.: US 2005/0260905 A1
(43) Pub. Date: Nov. 24, 2005

(54) Textile material finished with polymeric cyclodextrins, and method for the production thereof

(76) Inventors: Hans-Jurgen Buschmann, Kempen (DE); Eckhard Schollmeyer, Rheurdt (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/433,707

(22) PCT Filed: Dec. 7, 2001
(86) PCT No.: PCT/EP01/14367

§ 371 Date: Nov. 12, 2003

(30) Foreign Application Priority Data
Dec. 7, 2000 (DE) 100 60 710.1

(51) Int. Cl. B32B 5/02

(52) U.S. Cl. 442/59

(57) ABSTRACT

The invention relates to a textile material with a cyclodextrin finishing having a polymeric matrix containing cyclodextrin and/or a cyclodextrin derivative, as well as a method for the manufacture of such a textile material.

The invention relates to a textile material with a cyclodextrin finishing and a method for its manufacture and the use of the material.

Generally speaking, cyclodextrins are cycloamyloses and cycloglucans formed as cyclic dextrins by Bacillus macerans and, resp., Bacillus circulans when de-composing starch under the influence of cyclodextringlycosyltransferase. They consist of 6, 7, or 8 glucose units linked into an α-1,4 cycle which defines the α-, β- and γ-cyclodextrins. These are embedded into a crystal lattice and superimposed in such a manner that they form continuous intramolecular channels where they are capable of encapsulating hydrophobic guest molecules, e.g. gases, alcohols or hydrocarbons, in various quantity until a state of saturation is reached. This process is known as “molecular encapsulation” (Römpp “Chemie Lexikon”, Vol. 2, 1995, 9^{th} extended edition). Due to this property cyclodextrins are employed in the production of foodstuff, cosmetics, pharmaceuticals and pesticides as well as in solid phase extraction.

It is known that by making use of a complexation process cyclodextrins are employed to convert compounds of poor solubility into a soluble complex.

In the Journal of Inclusion Phenomena and Molecular Recognition in Chemistry 27 (1997), p. 69-84, Reuber, A. et al. illustrate that dimeric cyclodextrins having a high binding affinity for porphyrinoid photosensitizers are used as carrier system for agents employed in photodynamic cancer therapy.

In Tetrahedron Letters 25 (1984), p. 5533-5536 Fujita, K. et al. describe the production of ditosylates of β-cyclodextrin and their purification by reverse-phase chromatography.

WO 99/24474 discloses specific cyclodextrin oligomers that as a result of a spacer consist of a rigid and preferably hydrophilic structural element and enable pharmaceutical agents to be detoxified.

DE-A 198 25 486 discloses absorptive polymerisates in which cyclodextrins or cyclodextrin derivates are present in ionic, covalent form or through mechanical inclusion. These serve to absorb aqueous solutions such as body fluids, e.g. urine, for hygiene applications, as packaging material, as carrier substances and/or as stabilizer for fertilizers or as soil enhancing agents.

It is a well known practice to provide textile materials such as, for example, a fiber, a filament, yarn, textile bulk or area-measured material with a finishing to purposefully modify their properties. Such finishes may, for instance, lessen wrinkling and lend soil-resisting or soil-proofing qualities. Generally speaking, cellulose-containing textile materials are thus provided with a urea-formaldehyde-product finish. This enables the wrinkling tendency of the material to be diminished. Furthermore, finishes are known that improve the soiling behavior of textile materials or make it easier to remove dirt when washing the material. These so-called soil-release finishing products are polymers. As an example of such products polyacrylates shall be mentioned here that are applied to the textile material during the refining process. This type of finish enables soiling or stains to be eliminated more easily and, additionally, makes it more difficult for dirt to penetrate into the textile material. To prevent the penetration of dirt so-called stain-repellency finishes can be employed. These soil-repellent finishes serve to provide the outer surface of the textile material with a protective polymeric layer. As an example of such polymeric compounds fluorocarbon acids shall be named here.

DE-A 40 35 378 discloses textile materials provided with cyclodextrins or cyclodextrin derivates that serve to absorb non-polar dirt, sweat and sweat decomposition products or scents. The application of the cyclodextrin compounds takes place either directly via the spinning process, a chemical or a physical variant. The chemical variant involves the reaction of the textile material by linking it with the cyclodextrin compounds. In the event the linking process is not fully successful the cyclodextrins are washed out and this is true for both the chemical and the physical attachment method. Moreover, a chemical attachment is as a rule rather intricate and/or cost-intensive.

Therefore, there is a need for synthetic and natural textile materials that are stably modified with cyclodextrins.

It is thus the object of the present invention to permanently finish a textile material with cyclodextrin or cyclodextrin derivates as well as provide a method for the production of this material.

According to the invention the objective is reached by using a textile material having a cyclodextrin finish having a polymer matrix containing cyclodextrin and/or a cyclodextrin derivative.

The textile material according to the invention does not or does not primarily contain cyclodextrin that is chemically bonded to the fiber but forms part of a polymeric matrix which is applied and/or introduced. The polymeric matrix preferably contains cyclodextrin as one of the basic constituents, though further basic constituents that are required for the creation of a warp or net structure may be present. Especially preferred is that the polymeric matrix is produced in the presence of the textile material so that the textile material itself and the polymeric matrix form an interwoven structure. In this way a high-cyclodextrin-containing textile material is produced without the cyclodextrin being chemically attached. The detriment encountered with textile materials finished with cyclodextrin in the known manner, that involved the cyclodextrin-containing polymeric matrix being “washed out” of the textile material due to mechanical influences, solvent effects or hydrolysis effects of basic detergents, does no longer exist.

Expediently, the proportion of the cyclodextrin and/or cyclodextrin derivatives containing polymeric matrix ranges between 0.2 and 80% by weight based on the textile material, preferably between 1 and 40% by weight based on the textile material and most preferably between 2 and 30% by weight.

The amount of cyclodextrin and/or cyclodextrin derivatives and thus of the polymeric matrix that the material finished according to the invention contains depends on the respective application of the material. The textile material finished according to the invention preferably has a cyclodextrin content ranging between 2 and 30% by weight and most preferably between 7 and 20% by weight. Surprisingly, it was found that with the textile material provided with a polymeric matrix according to the invention a permanent improvement of the applications according to the invention took place. The voids created by the cyclodextrin compounds may thus serve to absorb liquids, gas and solids such as cosmetics, pharmaceuticals, scents and flavoring substances.

Another object of the invention is the provision of methods aimed at manufacturing the finished textile material. This involves in a
first step to apply to the textile material an aqueous and/or organic solution consisting of cyclodextrins and/or cyclodextrin derivatives with or without additives;
second step the partial drying and
in a third step that the textile material is brought into contact with a second polymer-forming component and polymerizes.

The aqueous or organic solution of cyclodextrin and/or cyclodextrin derivatives employed in the first step contains the cyclodextrin or cyclodextrin derivative as first polymer-forming component. It goes without saying that the cyclodextrins or their derivatives are polyfunctional, i.e. have at least two functions suitable for polymer-formation. Moreover, the solution may contain further customary additives required for the formation of polymers or promoting polymer formation.

As functions of cyclodextrin derivatives suited for polymer formation other functions, aside from the naturally existing hydroxy function, suitable for cross-linking can be considered that can be produced by transforming or modifying the hydroxy function in a manner known in the trade. Such functions are, for example, halogen atoms, amino, carboxy, isocyanate and thiol groups.

In the framework of the invention the term “cyclodextrins” shall cover α-, β- and γ-cyclodextrins.

In the framework of the invention the term “cyclodextrin derivatives” shall cover functionalized and derivativized cyclodextrins, as well as those partially methylized, ethylized and otherwise substituted.

In the framework of the invention the term “textile material” shall mean that the textile materials represent, for example, fibers, filaments, yarns, bulk or area-measured materials.

The term textile material shall cover both natural and synthetic materials or materials that contain synthetic fibers. Natural materials in this context are cotton, wool, linen or silk. Textile fibers on cellulose basis in this context are cotton, linen, spun rayon or viscose silk. This also includes viscose, cuprammonium fiber and acetate. By the term “synthetic fibers” fully synthetic fibers are known that are made from simple components by polymerization, polycondensation or polyaddition. This includes elastane, elastodiene, fluoro fiber, acrylic, modacrylic, polyamide, aramid, polyvinyl chloride, polyvinylidene chloride, polyester, polyethylene, polypropylene and vinylal. Synthetic-fiber containing materials are those that contain both the purely synthetic fiber and also natural materials such as those on cellulose basis. The textile materials according to the invention also include, in particular, those made of synthetic fibers that in respect of the polymeric components of the cyclodextrin polymer do not have reactive groups.

As second polymer-forming component, in particular, polyalcohols, polyamines or other polyfunctional molecules with at least two functions suitable for cross-linking can be considered. To achieve a flexible product the use of chain lengths of C₂ to C₁₂, in particular C₄ to C₁₀ of these cross linking agents are preferred with aliphatic polyfunctional cross-linking agents being preferred over the aromatic ones. Further examples of the second polymer-forming component are di- and/or polyfunctional compounds such as dicarboxylic acids, anhydrides of di-carboxylic acid, diisocyanates, aminocarboxylic acids, diols, diamines or thiols. Moreover, 1,3,5-trichloro-2,4,6-triazine, 2,3-dichloroquinoxaline-5- and -6-carboxylic acid chloride as well as chloro-difluoric pyrimidin in Frage. A cross-linking of cyclodextrins may further be brought about using alkoxysilanes or alkoxysiloxanes, especially silanes and siloxanes having two or more alkoxy groups. Preferred are the ethoxy compounds.

The textile materials provided with a finish according to the invention also include those made of synthetic fibers that do not possess any reactive groups capable of influencing the polymerization process. For this purpose the above described two-stage manufacturing process is particularly appropriate. When applying the two-stage method to textile materials containing reactive groups and, particularly, to cellulose-based textile fibers, it is unavoidable that chemical bonds are established as well between the cellulose material and the polymeric components even to such an extent that the formation of the separate polymeric matrix may substantially diminish in favor of the attachment.

This latter aspect can be avoided by making use of another variant of the method according to which a mixture of a cyclodextrin and/or cyclodextrin derivative and a second polymer-forming substance, dissolved in an inert solvent where appropriate, is applied to a textile material under cross-linking conditions and at a time the cross-linking process has already commenced and in this way bringing the cross-linking process to an end.

When this variant of the method is employed cyclodextrin and a second polymer-forming component reactive with it, for example a diisocyanate, a dicarboxylic acid chloride, an anhydride of dicarboxylic acid or similar substance, are expediently mixed using customary auxiliary agents if required, for example catalysts, and, if need be, dissolved in a non-reactive solvent so that the cross-linking reaction is initiated. While undergoing cross-linking the mixture is then applied to the textile material in a customary manner and introduced into it, for example by spraying or impregnation so that the cross-linking process can be effected.

For this reaction especially cyanuric chloride can be used inter alia. Especially preferred materials for the second component are di- and polyisocyanates in their monomeric or oligomeric forms, for example hexamethylene diisocyanate, isophoron diisocyanate as well as MDI or TDI. The mixture of the two components and the application are suitably matched to each other so that when coming into contact with the textile material partial polymerization (prepolymer formation) has already taken place and final cross-linking being effected on and inside the textile material. By admixing minor amounts of water (less than 1% by weight, preferably 0.2 to 0.5% by weight) a foaming action may be induced additionally.

In principle, the polymerization of the respective components takes place before, during and after their application upon the textile material at the usual temperatures envisaged for the respective materials and within the normal time frame. The removal of solvents or solvent remnants, if necessary, is done at temperatures conducive to and acceptable for the relevant textile material.

This single-stage method is particularly appropriate when a polymeric matrix is to be formed in textile materials composed of natural fibers containing reactive hydroxy or amino functions. The rapidly commencing crosslinking action still taking place separate from the textile material is suitable to limit the reaction of the crosslinking agent with the textile material to such an extent that a primarily polymeric matrix is produced and only relatively few points of linkage with the textile material are established.

When employing the multistage method the first reaction step, for example, is effected at temperatures ranging between 40 and 140° C., preferably between 50 and 90° C. in the aqueous and/or organic solution containing the cyclodextrins or cyclodextrin derivatives.

Polar solvents are used, for example water, lower alcohols, amines or dimethyl formamide. Preferred here is the use of water or an alcohol from the group of methanol, ethanol, propanol, isopropanol or butanol.

Following this the solvent is removed in conjunction with a drying step at temperatures ranging between 60 and 150° C.

The treatment time required with the multistage method depends on the respectively used textile material and the treatment time and may vary between 5 minutes and 120 minutes.

Following the drying step the pretreated textile material is wetted with the polymer-forming component and the polymerization reaction of the polymer-forming component takes place to produce a three-dimensional polymeric matrix. The temperature at which the polymeric matrix is finally formed depends on the reactivity of the polymerization reaction and may even occur at room temperature. Depending on the monomer component employed an elevated temperature as high as 150° C. may even be required. The reaction time of the third step which involves the polymeric matrix formation itself and the simultaneous linking of the polymeric matrix with the textile material also depends on the reactivity of the monomers and ranges between 2 and 120 minutes.

The textile material containing the polymeric matrix according to the invention is built in such a manner that the polymeric matrix and the existing textile material form a “mixed woven fabric” that contains cyclodextrin as a component of the polymeric matrix.

As second polymer-forming component particularly dimethylol urea (DMU), di-methoxy methoxy methyl urea (DMUMe₂), methoxy methyl melamin, dimethylol ethyl urea (DMEU), dimethylol dihydroxy ethylene urea (DMDHEU), dimethylol propylene urea (DMPU), dimethoxy methyluron, tetramethylol acetylidene urea, di-methylol carbamate and/or methylol acrylamide may also be used. These polymer-forming components react with the hydroxy groups of the cyclodextrins or cyclodextrin derivatives by forming the polymeric matrix. A two- and/or three- dimensional polymeric matrix will be produced. Since these polymer-forming components react with the hydroxy functions of cellulose-containing materials as well their application is preferred for the single-stage mixing process or, as far as the multistage process is concerned, upon textile materials of non-reactive synthetic fibers.

The polymeric matrix of the textile material may, for instance, be present in the form of a polyester and be produced via a polycondensation reaction between cyclodextrin and, for example, a dicarboxylic acid or its derivative as second monomer. The numerous hydroxy functions of the cyclodextrin make sure that an extensive spacious cross-linking is achieved. The reaction of cyclodextrins with polyisocyanates is a polyaddition.

It goes without saying that the invention also embraces the use of functionally modified cyclodextrins, for example cyclodextrins possessing isocyanate, amino, thiol, carboxylic functions or functions derived from carboxylic groups. These may be transformed into the desired polymeric matrix in a way known per se in the trade by making use of suitable crosslinking agents.

When transforming the relevant polyisocyanates using water and/or polycarboxylic acids a polymer may be produced for example that adheres to the textile material in the form of a finely dispersed foam and brings about a surface-near and easily accessible arrangement of the cyclodextrin units.

Another object of the invention is the use of textile materials that are manufactured by the method and involve the dispensing of pharmaceutically effective substances and the discharge of cosmetics and scents and perfume substances.

Another possible application is in the field of medical diagnostics. For example, the organic constituents of sweat may thus be intercepted and analyzed.

In another possible application the textile materials manufactured according to the invention can be employed with a view to absorbing atmospheric contaminants. This also includes any conceivable kind of filtration application in conjunction with various non-woven or woven fabrics and materials. Moreover, the textile materials may also be used for the inclusion of hydrophobic or partially hydrophobic substances stemming from aqueous phases of wastewater and water treatment systems and for the cleaning and concentration of substances, for example metals.

The textile materials used in the field of filtration applications may preferably be of rigid or stiff nature and may also be provided with a higher content of cyclodextrin, cyclodextrin derivatives or mixtures of both. In this context such materials are preferred that posses a finely-dispersed foam applied to the surface of the textile material so that the material's surface is further enlarged.

Surprisingly, it has been found that the textile materials finished as provided by the invention had an extremely long service life in any of the applications which was due to the fact that the cyclodextrin components remained stably bonded within the matrix and were hardly affected by hydrolysis phenomena.

### EMBODIMENT EXAMPLES

### Example 1

A cotton and a polyester standard fabric having a mass per unit area of 100 g/m² were treated in the liquor bath detailed below and then padded, with the textile material being initially immersed in the bath for 2 minutes and subsequently padded at 3 m/min and at a line pressure of 50 kp/cm². Following a drying process of 90 minutes at a temperature of 150° C. the fabric treated in this manner was allowed to condense out for a period of 2 minutes. The basic composition of the liquor bath consisted of dimethylol urea in the amount of 50 g/l, of magnesium chloride hexahydrate in the amount of 10 g/l, of ammonium sulfate in the amount of 1 g/l and of β-cyclodextrin. A total of six basic compositions were made to which β-cyclodextrin in the amount of 0 g/l, 10 g/l, 20 g/l, 30 g/l, 40 g/l and 50 g/l respectively was admixed.

Following this the fabric samples previously finished with cyclodextrin and the polymer-forming component were immersed in a standard solution consisting of butyric acid (10 g/l). Following a squeezing and rinsing process the remaining butyric acid concentration was determined by gas chromatography. It was found that as the concentration of β-cyclodextrin was increasing larger amounts of butyric acid were absorbed which was accompanied by a decrease of the butyric acid concentration, and this is also evident from FIG. 1.

Additionally, the fabric samples provided with the finish were washed fifty times each in accordance with the conditions described above. After this, these materials were again immersed in the standardized butyric acid solution, squeezed out and rinsed. It was again determined that the butyric acid concentration had diminished. The measured values ascertained in the liquor bath coincided with those of the first measurement.

Both textile materials basically exhibited the same results.

### Example 2

The procedure outlined under Example 1 was repeated using the same cotton and polyester standard fabrics, but the treatment started with the cyclodextrin solution followed by a gentle drying process and subsequent impregnation treatment in a liquor bath consisting of dimethylol urea, magnesium chloride hexahydrate and ammonium sulfate. Subsequently, the material was again dried gently and then condensed out under standard conditions.

With the polyester standard fabric a product was obtained that contained the cyclodextrin completely integrated into the polymeric matrix. The cotton standard fabric still contained numerous attachments of the polymeric matrix to the fiber with the cyclodextrin, however, being predominantly present in the polymeric matrix.

### Example 3

The fabric materials described under Example 1 were impregnated using a mixture of 10 g/l β-cyclodextrin and 5 g/l hexamethylene diisocyanate with an amine catalyst (DMDEE) in methylene chloride. The mixture was produced immediately before application and applied while the crosslinking action continued.

With both fabrics a polymeric matrix was obtained that formed part of the textile material without being chemically bonded to it to an appreciable extent.

1. Textile material provided with a cyclodextrin finish, wherein said material comprises a polymeric matrix containing the cyclodextrin and/or a cyclodextrin derivative, in which the content of the cyclodextrin amounts to between 2 and 30% by weight, based on the textile material and wherein said cyclodextrin and/or cyclodextrin derivative is not chemically attached to the textile material.

2-3. (canceled)

4. Textile material according to claim 1, wherein the cyclodextrin is present in the form of β-cyclodextrin.

5. (canceled)

6. Textile material according to claim 1, wherein the polymeric matrix is a cyclodextrin-containing polyester or polyurethane.

7. Textile material according to claim 1, wherein the polymeric matrix is obtained by crosslinking of cyclodextrin with a polyalcohol, a polycarboxylic acid, a polyisocyanate, an alkoxysilane or -siloxane or with cyanuric chloride.

8. A method for the manufacture of the textile material according to claim 1, wherein in a
first step an aqueous and/or organic solution consisting of cyclodextrin or cyclodextrin derivative with or without additives is applied to the textile material;
in a second step partial drying is effected, and
in a third step the textile material is brought into contact with a second polymer-forming component and polymerizes.

9. A method according to claim 8, wherein no chemical bonding of cyclodextrin to the textile material is effected when the cyclodextrin or cyclodextrin derivative is applied during the first step.

10. A method according to claim 8, wherein a β-cyclodextrin or a β-cyclodextrin derivative is used as the cyclodextrin or cyclodextrin derivative.

11. A method according to claim 8, wherein the cyclodextrin derivatives used are derivatives with C₁₋₁₄ alkyl, carbonyl, carboxyl, isocyanate, thiol or amino groups.

12. A method according to claim 8, wherein natural or synthetic materials are used as the textile materials.

13. A method according to claim 8, wherein the textile materials are selected from the group consisting of fibers, filaments, yarns, bulk and area-measured materials.

14. A method for the manufacture of the textile material according to claim 1, wherein in a first step a mixture of a cyclodextrin and/or a cyclodextrin derivative and a second polymer-forming component, dissolved in an inert solvent where appropriate, is applied to a textile material under cross-linking conditions and at a time the cross-linking process has already commenced, and the textile material is dried in a second step.

15. A method according to claim 14, wherein natural textile materials are used.

16-18. (canceled)
